(19) United States
(12) Patent Application Publication
(10) Pub. No.: US 2009/0157441 A1
(43) Pub. Date: Jun. 18, 2009

(54) AUTOMATED SLA PERFORMANCE TARGETING AND OPTIMIZATION

(75) Inventor: Stephen M. Curry, Holly Springs, NC (US)

Correspondence Address: VERIZON;PATENT MANAGEMENT GROUP, 1320 North Court House Road, 9th Floor, ARLINGTON, VA, 22201-2909, US

(73) Assignee: MCI Communications Services, Inc., Ashburn, VA (US)

(21) Appl. No.: 11/955,740

(22) Filed: Dec. 13, 2007

(51) Int. Cl. G06Q 10/00

(52) U.S. Cl. 705/7

(57) ABSTRACT

Methods relating to the generation of service level agreement (SLA) performance report include measuring, over a service period, at least one service level measurement related to a provision of service. A measurable SLA commitment may include service level goals, with each goal containing a performance criterion, a target, and a comparison technique. A performance report may be generated based on the measurable SLA commitment and the at least one service level measurement and may include a goal analysis for each service level goal of the measurable SLA commitment. A system including a database and a report processor may be configured to generating a performance report including determining an actual level of service provided, comparing the measurable SLA commitment to the actual level of service provided, and determining a missed goal based on the actual level of service provided not realizing the SLA goal.

### BACKGROUND

A service level agreement (SLA) can exist as a contractual commitment between a service provider and a consumer of a service. An SLA may be written as a legal contract including one or more contractual commitments detailing the quality, or level, of service that the consumer of the service can expect to receive. However, the format of such a legalistic, or contractual, SLA may make it difficult to ascertain whether the actual level of service provided complies with the SLA. The actual level service may be determined according to one or more service level measurements, but the service level measurements may not necessarily correspond to a predefined SLA commitment. Therefore, service providers lack automated systems and methods for determining whether the actual level service provided to a consumer of the service corresponds to the contractual SLA commitment.

If a consumer of a service alleges that the actual level of service has failed to meet the contractual SLA commitment, the service provider may need to complete an audit of various records to determine the validity of the complaint. Such an audit may be an onerous process conducted manually by service provider personnel. Additionally, the records available to a service provider may lack the service level measurements necessary to conduct an audit. Even if records containing service level measurements exist it may be difficult to correlate the measurements to the commitment. Accordingly, if a contractual commitment under an SLA could be converted into a measurable commitment, an automated process may be able to conduct SLA compliance reporting and eliminate the burden of audits currently placed on service provider personnel.

Additional problems may arise when an audit of a contractual SLA commitment validates an allegation that the actual level of service failed to meet the SLA. The service provider may wish to offer an appeasement to the consumer of the service. However, because of the difficulty with the audit process, an appeasement offered to the consumer of the service may be ad hoc and inconsistent with appeasements offered to other consumers of the service. Additionally, an appeasement may be imprecisely correlated to the degree that the actual level of service failed to meet the contractual SLA commitment.

Consumers of the service are unlikely to notify the service provider regarding an actual level of service that exceeds a contractual SLA commitment. Accordingly, service providers may not realize when the actual level of service exceeds such a contractual commitment. Therefore, service providers may miss an opportunity to receive compensation that is commensurate with the actual level of service.

Customer service departments of service providers may collect data regarding service issues. Such data is commonly referred to as a trouble ticket, or simply a ticket, and may be stored in a database system utilized by the customer service department. Tickets generally serve the narrow purpose of facilitating repairs related to the service issue identified therein. However, an aspect of this facilitation may include the recording of certain service level measurements in a ticket. Tickets may therefore provide service level measurements for use in determining the degree to which an actual level of service corresponds to a contractual SLA commitment.

### BRIEF DESCRIPTION OF THE DRAWINGS

FIG. 1a illustrates an exemplary system for automated service level agreement performance targeting and optimization;

FIG. 1b illustrates an exemplary telecommunication network;

FIG. 1c illustrates an exemplary customer service management center;

FIG. 1d illustrates an exemplary SLA reporting system;

FIG. 2 illustrates a set of exemplary database entities for automated service level agreement performance targeting and optimization;

FIG. 3 illustrates an exemplary dataflow diagram related to the development of a measurable service level agreement based on a contractual service level agreement;

FIG. 4 illustrates an exemplary dataflow diagram related to the generation of a service level agreement performance report;

FIG. 5a illustrates a flowchart depicting exemplary steps and decisions relating to developing a measurable service level agreement from a contractual service level agreement;

FIG. 5b illustrates a flowchart depicting exemplary steps and decisions relating to the generation of a service level agreement performance report; and

FIG. 6 illustrates a flowchart depicting exemplary steps and decisions related to isolating a missed goal.

### DETAILED DESCRIPTION

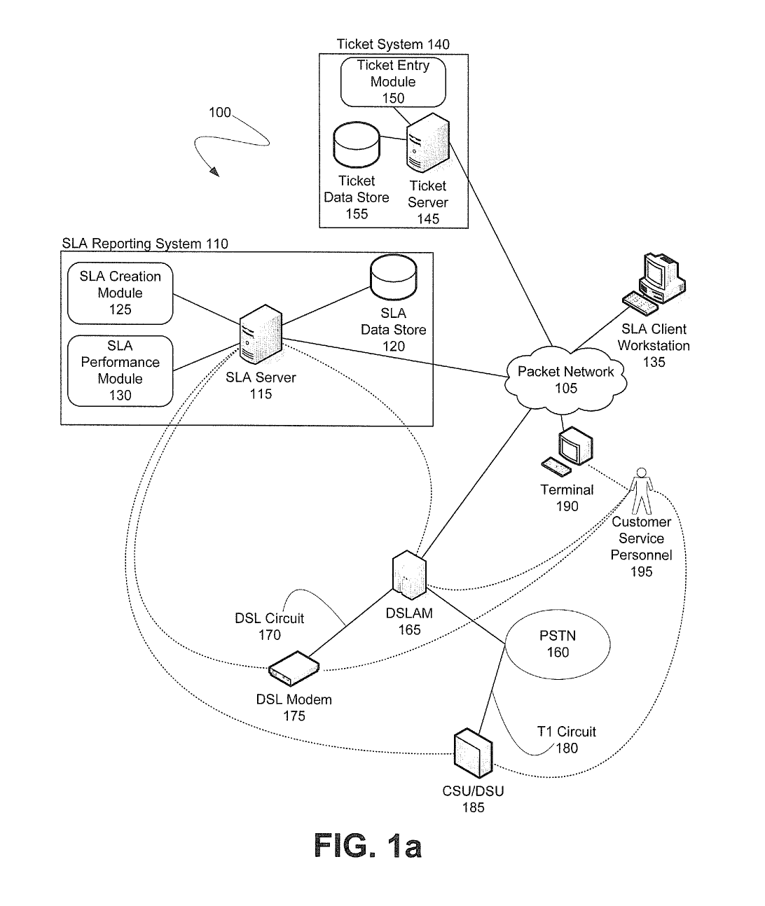

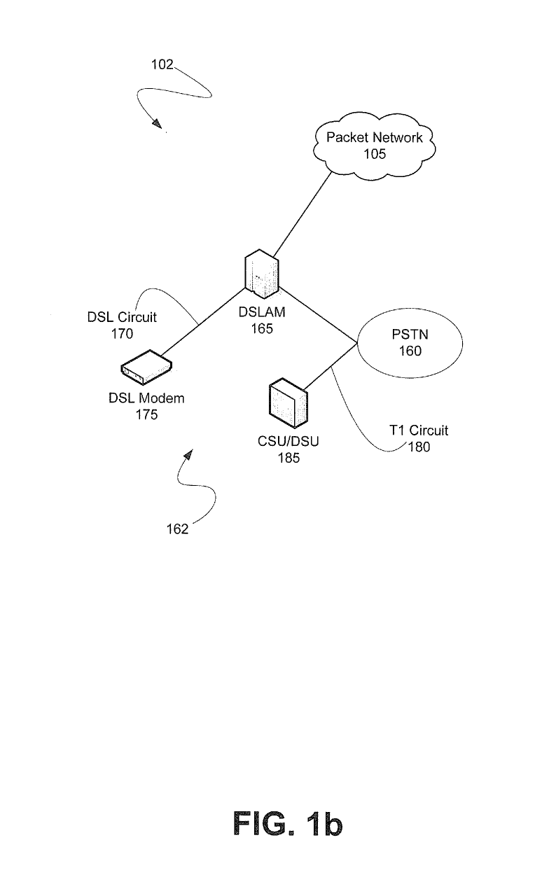

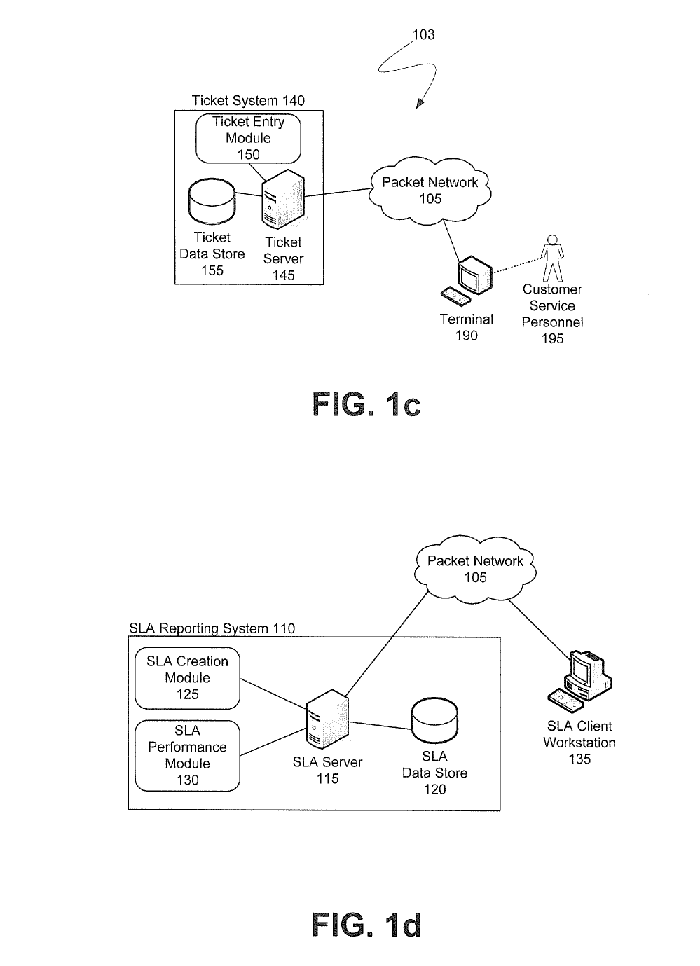

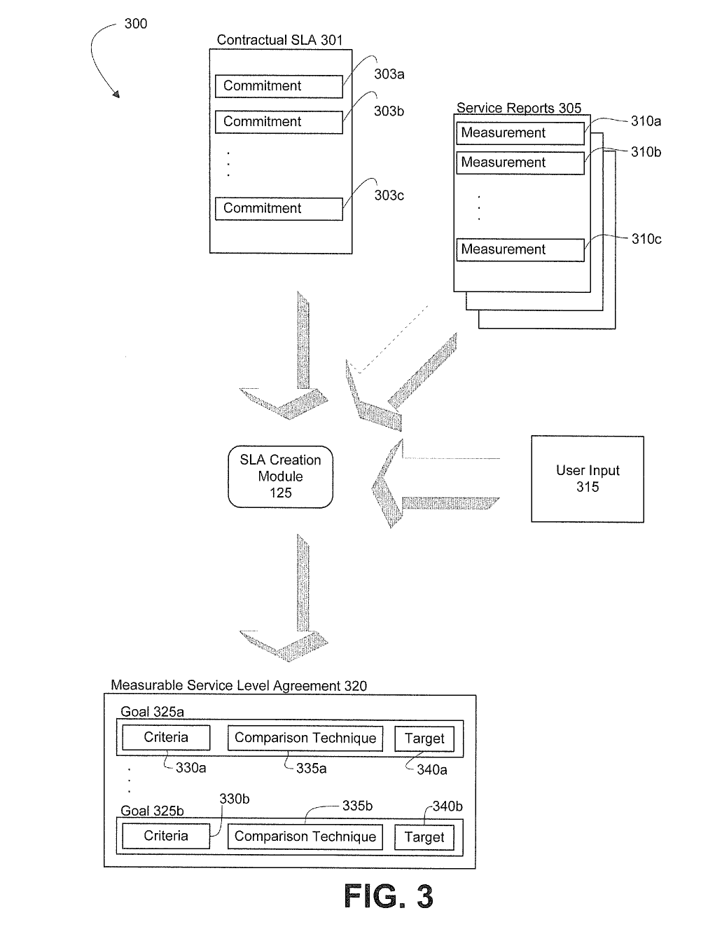

FIG. 1a illustrates an exemplary system 100 for converting a contractual SLA commitment 301 (FIG. 3) to a measurable SLA commitment 320 (FIG. 3) and for conducting automated performance targeting and optimization of the measurable SLA commitment 320. While each element will be discussed in detail below, the following overview offers a brief explanation of the relationships of the various subsystems and data to each other.

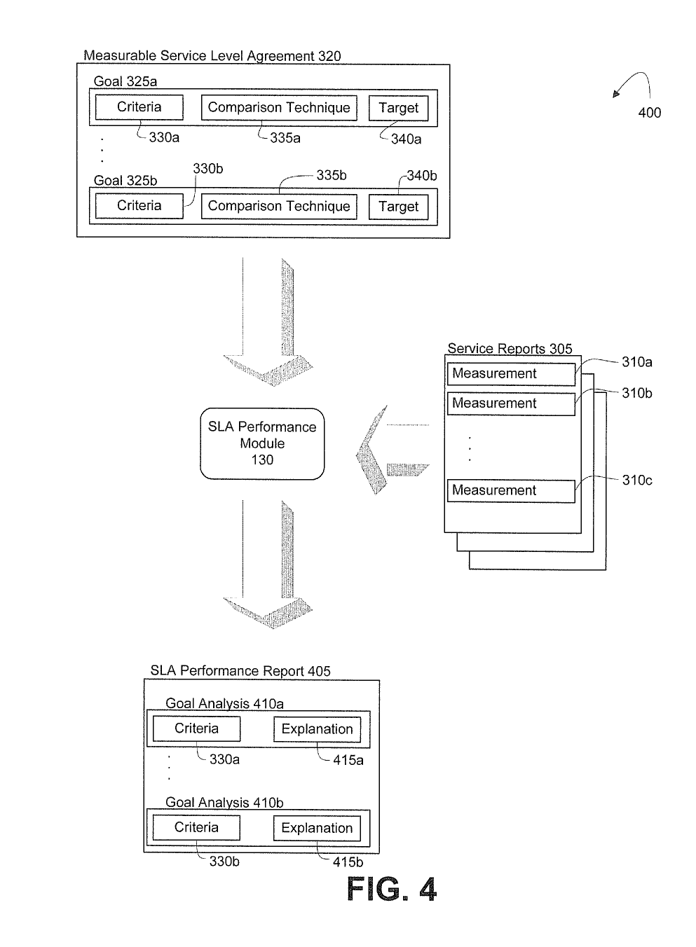

A telecommunications network 102 (FIG. 1b) may be provided by a network service provider and may be monitored by a customer service management center 103 (FIG. 1c). The dashed lines of FIG. 1a represent the monitoring of network devices 162 (FIG. 1b) that may be conducted by an SLA reporting system 110, or by customer service personnel 195 of management center 103. Monitoring data related to network devices 162 that is collected by management center 103 may be stored as tickets in a ticket system 140. Tickets in a ticket data store 155 may be imported into an SLA data store 120 for use as service reports 305 (FIG. 3). Service reports 305 may also be generated from the direct monitoring of network devices 162 by SLA reporting system 110. Service reports 305 may provide measurements 310a-c (FIG. 3) that can be used to determine the actual level of service provided to a consumer of the service. SLA reporting system 110 may provide an SLA creation module 125 for converting a contractual SLA commitment 301 into a measurable SLA commitment 320. An SLA performance module 130 may use service reports 305 in order to determine whether the actual level of service provided to a consumer of the service met the goals 325a-b (FIG. 3) of the measurable SLA commitment 320 through the generation of an SLA performance report 405 (FIG. 4).

FIG. 1b illustrates an exemplary telecommunications network 102 provided by a network service provider. Network 102 may include both a packet network 105 and a traditional public switch telecommunication network 160. Interconnections between packet network 105, PSTN 160, and network devices 160 may be provided by circuits such as a digital subscriber line (DSL) circuit 170 and a T1 circuit 180.

Packet network 105 may be a local-area network (LAN) or a wide-area network (WAN). Packet network 105 may further be a packet switched communication network such as an Internet Protocol (IP) network. Packet network 105 generally interconnects various computing devices and the like, such as an SLA server 115 and an SLA client workstation 135. Interconnections in packet network 105 may be made by various media including wires, radio frequency transmissions, and optical cables. Other devices connecting to packet network 105, e.g. switches, routers, etc., are omitted for simplicity of illustration in FIG. 1.

Public switch telephone network (PSTN) 160 may be a traditional telecommunications network. PSTN 160 may include circuit switched connections for use with voice based communications. PSTN 160 may allow telephone devices (not shown) to communicate according to a common protocol, e.g. signaling system seven. While depicted as only a single element for simplicity, PSTN 160 may include local loop connections, local switching offices, trunk lines, etc.

A digital subscriber line access multiplier (DSLAM) 165, a digital subscriber line (DSL) modem 175, and a Channel Service Unit/Data Service Unit (CSU/DSU) 185 are all examples of network devices 162. DSLAM 165 may allow local copper communications infrastructure of PSTN 160 to be used as a DSL circuit 170 for use with data transmission. DSLAM 165 allows DSL circuit 170 to carry both voice and data transmissions. Voice signals are passed to PSTN 160 while data transmissions are passed to packet network 105. DSLAM 165 may be provided at a local switching office or may be distributed to the vicinity of the customer premises. A DSL modem 175 acts as a terminal to DSL circuit 170 and provides a connection for customer equipment. DSL modem 175 is typically located at the customer premises. DSLAM 165 may also aggregate data transmissions from multiple DSL modems 175. The aggregated data transmissions may be passed to packet network 105 via various any of a number of protocols, e.g. time division multiplexed (“TDM”) systems, SONET/SDH or PDH, Internet Protocol (“IP”) systems or asynchronous transmission mode (“ATM”) backbones).

A channel Service Unit/Data Service Unit (CSU/DSU) 185 is a network device that acts as a terminal of a T1 circuit 180 by bridging the connection between a Local Area Network (LAN) (not shown) and a Wide Area Network (WAN), e.g. PSTN 160. While typically referred to as a single element, CSU/DSU 185 provides two distinct functions, which may be carried out by two distinct devices. The CSU of CSU/DSU 185 receives and transmits signals from and to the WAN and provides a barrier for electrical interference from either side of the unit. The CSU can also echo loopback signals from the service provider for testing purposes. The DSU of CSU/DSU 185 manages line control of T1 circuit 180, and converts the data transmission frames of the LAN to the time-division multiplexed frames of the T1 circuit 180. The DSU typically manages timing errors and signal regeneration. The DSU provides a modem-like interface between customer equipment (not shown) and the CSU.

FIG. 1c illustrates an exemplary customer service management center 103 maintained by the service provider of telecommunications network 102. Network devices 162 may experience service issues from time to time. Consumers of the service may report these service issues to a customer service representative 195. Management center 103 may include a ticket system 140 for recording information about the service issues. Ticket system 140 may be maintained solely by management center 103, or may be shared by other management centers (not shown). Management center 103 may be a network operations center (NOC).

Management center 103 may employ one of many generally available helpdesk management systems as ticket system 140, e.g. Remedy, Kaseya, OneOrZero, etc. Such systems typically allow customer service representatives 195 to receive service reports related to service issues from customers. These reports may be stored to a database such as ticket data store 155, for use by other customer service personnel such as repair technicians. Such systems typically refer to stored service reports as trouble tickets, or just tickets. A ticket may be initiated by customer service representative 195 or by a customer in response to a service issue faced by the customer. Customer service representative 195 may provide further information and prepare the ticket for a repair technician. The repair technician may provide follow-up information on the ticket regarding any repairs related to the service issue as well as the amount of time required to resolve the service issue. The data entered to complete a ticket may include service level measurements. Accordingly, tickets may constitute service reports 305 (FIG. 3) that may be used by SLA reporting system 110.

Ticket server 145 may be a server based computer system, such as a web application server, configured to provide a helpdesk management system or ticket system like the one just described. However, any computing device having a computer readable medium including instructions for communicating with ticket data store 155 may act as ticket server 145. Ticket server 145 may be a networked computer system configured with server software for accepting connections via packet network 105. Ticket server 145 may provide a graphical or command line user interface 150 for use by customer service personnel 195. Additionally, ticket server 145 may provide an interface of remote procedure calls that allow remote systems to interact with ticket server 145. Accordingly, ticket server 145 may act as an intermediary to ticket data store 155. Customer service representative 195 may use a terminal 190 or other networked computing device connected to packet network 105 in order to access the ticket entry interface 150 of ticket server 145. For instance, terminal 190 may provide a web browser in order to access a web based ticket entry interface 150.

Ticket data store 155 may be a relational database management system (RDBMS). Many such systems, including SQL Server, Oracle, and MySQL, among others, are generally available. Ticket data store 155 generally stores ticket data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

FIG. 1d illustrates an exemplary SLA Reporting system 110 as well as a workstation 135 connecting thereto via packet network 105. SLA reporting system 110 may be a computer based system, such as the combination of SLA server 115 and SLA data store 120. SLA reporting system 110 provides a platform for developing measurable SLA commitments 320 (FIG. 3) and for comparing the actual level of service provided to the measurable SLA commitment 320 through the production of a SLA performance report 405 (FIG. 4). SLA reporting system 110 may rely on service reports 305 (FIG. 3), including data collected for purposes other than SLA performance monitoring, in order to determine the actual level of service provided. For instance, service reports 305 may include data imported from ticket system 140. Additionally, SLA server 115 may create service reports 305 by directly monitoring network devices 162. As discussed above, the dashed lines of FIG. 1a represent the transmission of service reports from network devices 162. While FIG. 1d merely depicts a single SLA server 115 and a single SLA data store 120, it is to be understood that SLA reporting system 110 may include a pool of SLA servers 115 and SLA data stores 120.

SLA server 115 may be a server based computer system, such as a web application server, configured to provide SLA creation and SLA performance monitoring functionality. However, any computing device having a computer readable medium including instructions for modules 125, 130 may act as SLA server 115. SLA server 115 may be a networked computer system configured with server software for accepting connections via packet network 105. SLA server 115 may provide a graphical or command line user interface for use by a human operator. The graphical user interface may be a web based interface including one or more web pages, or the like. Additionally, SLA server 115 may provide an interface of remote procedure calls, or the like, that allow remote systems to interact with SLA server 115. For instance, remote procedure calls may allow for the remote execution of SLA performance module 130.

SLA data store 120 may be a relational database management system (RDBMS). Many such systems, including SQL Server, Oracle, and MySQL, among others, are generally available. SLA data store 120 generally stores data for use by SLA server 115 in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table.

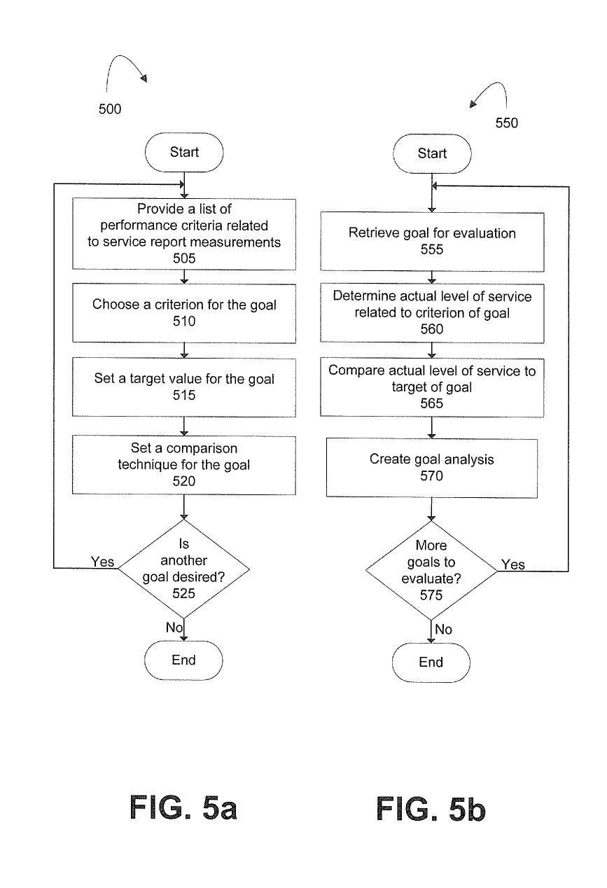

SLA creation module 125 may provide computer instructions for providing an interface for creating a measurable SLA commitment 320 (FIG. 3) and for processing user input 315 (FIG. 3) related to the creation of the measurable SLA commitment 320. The instructions of SLA creation module 125 may be executed by a user via controls or other interface elements. Such controls may be included in one or more web pages with web forms, or the like. SLA creation module 125 is described in more detail below with respect to FIGS. 3 and 5a.

SLA performance module 130 may provide computer instructions for comparing a measurable service level agreement 320 (FIG. 3) to an actual level of service provided. The instructions of SLA performance module 130 may be initiated by a user via the interface of SLA server 115. In another exemplary approach, SLA performance module 130 may be scheduled to run on a recurring periodic basis. SLA performance module 130 is described in more detail with respect to FIGS. 4 and 5b, below.

SLA client workstation 135 may be any general purpose computing device, such as a PC, connected to packet network 105 or a specialized device. SLA client workstation 135 may have software, such as an operating system with a network protocol stack, for connecting to SLA server 115 over packet network 105. SLA client workstation 135 may have additional software for accessing the user interface provided by SLA server 115. For instance, SLA client workstation 135 may have web browsing software to access a web based user interface of SLA server 115.

Computing devices such as SLA server 115, ticket server 145, SLA client workstation 135, etc., may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as SLA server 115, ticket server 145, SLA client workstation 135, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

SLA data store 120 and ticket data store 155 may include a query processor that employs Structured Query Language (SQL) in addition to a language for creating, storing, editing, and executing stored procedures, such as the Procedural Language/Structured Query Language (PL/SQL) utilized by Oracle, as mentioned above. SLA data store 120 and ticket data store 155 may be a type of database other than an RDBMS such as a hierarchical database, a set of files, an application database in a proprietary format, etc. SLA data store 120 and ticket data store 155 generally include a computing device employing a computer operating system such as one of those mentioned above, and is accessed via a network in any one or more of a variety of manners, as is well known. Exemplary systems are possible in which at least a portion of SLA data store 120 is provided by a database system used for purposes other than SLA performance targeting and optimization.

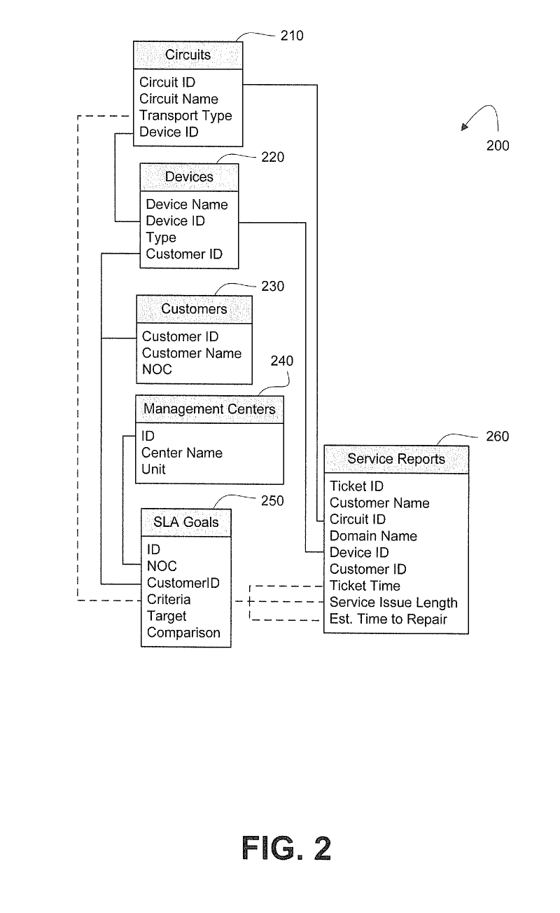

FIG. 2 illustrates an exemplary set of database entities, or tables, 200 that may be used with SLA data store 120. As discussed above, relational databases typically store data in tabular row and column format. It is to be understood that a relationship may be provided from a row of a first table to a row second table by including a value that identifies the row of the second table in a row of the first table. A circuits table 210 may include information about network circuits, e.g., DSL circuit 170, T1 circuit 180, including relationships to a devices table 220 and a service reports table 260. Relationships between circuits table 210 and devices table 220 identify the circuit used by a particular network device 162. Relationships between circuits table 210 and service reports table 260 identify the circuits, e.g., DSL circuit 170, T1 circuit 180, that have service reports 305 (FIG. 3) associated therewith.

Devices table 220 may include information about network devices 162 including relationships to a customers table 230, circuits table 210, and service reports table 260. Relationships between customers table 230 and devices table 220 identify which network devices 162 are associated with particular customers. Relationships between devices table 220 and service reports table 260 identify the network devices 162 that have service reports 305 (FIG. 3) associated therewith. Customers table 230 may include information about consumers of the service, or customers, including relationships to a SLA goals table 250. Relationships between customers table 230 and SLA goals table 250 associate SLA goals 325a-b (FIG. 3) with particular customers. A management centers table 240 includes information about management centers 103, including relationships to SLA goals table 250. Relationships between management centers table 240 and SLA goals table 250 associate SLA goals 325a-b (FIG. 3) with particular management centers 103.

SLA goals table 250 may store SLA goals 325a-b (FIG. 3). Service reports table 260 may store service reports 305 (FIG. 3) including service level measurements 310a-c (FIG. 3). Service level measurements 310a-c may include time values, e.g. ticket time, service issue length, estimated time to repair, etc. The service period of a service report 305 may be indicated by the ticket time field. In another exemplary approach, tickets table 260 may include an additional field (not shown) to store a date value, or the like, that indicates the service period. Data in service reports table 260 may originate from ticket data store 155. For instance, data from ticket data store 155 may be periodically imported into SLA data store 120. It is to be understood that ticket data store 155 may include additional tables and fields. The solid lines of FIG. 2 link corresponding fields that are used to form the relationships between the tables that were identified above. As will be discussed in greater detail below, the dashed lines FIG. 2 illustrate an exemplary set of fields that may be used as SLA goal criteria 330a-b (FIG. 3).

System 100 including database entities 200 support the collection of service reports (FIG. 3). Specifically, SLA reporting system 110 stores service reports 305 in SLA data store 120 in order to determine the actual level of service provided to the consumer of the service. Knowing the actual level of service provided may allow a service provider to determine whether the actual level of service meets the level of service that was agreed to in a contractual SLA commitment 301 (FIG. 3). However, comparing the actual level of service to a contractual SLA commitment 301 may require an onerous and manual process. Therefore, the following figures of data flows 300 and 400 and processes 500, 550, and 600 depict the development of a measurable SLA commitment 320 (FIG. 3) from a contractual SLA commitment 301 as well as the comparison of the actual level of service to the measurable SLA commitment 320.

FIG. 3 provides a dataflow diagram illustrating an exemplary flow 300 of data into and out of SLA creation module 125. SLA creation module 125 accepts at least one contractual SLA commitment 301, service reports 305, and user input 315 in order to produce at least one measurable service level agreement commitment 320. Service reports 305 may include reports of service issues such as the service issues that are stored as tickets in tickets system 140 and imported into service reports table 260. Additionally, service reports 305 may contain service level measurements 310a-c. Service level measurements 310a-c may provide an indication, individually or in the aggregate, of the actual level of service provided. A service report 305 may be associated with a consumer of the service either directly or indirectly through records in the circuits table 210 and devices table 220 by the database relationships discussed above. In another exemplary approach, service reports 305 may include direct analysis of service availability and quality. For instance, service reports 305 may be obtained by SLA server 115 through polling, or other network availability monitoring techniques. Such service reports 305 may include service level measurements 310a-c related to the quality of service, e.g., network transmission speed, latency, capacity, etc.

A contractual SLA commitment 301 may be the contractual agreement by which a service provider agrees to provide service to a consumer of the service. Contractual SLA commitment 301 may include at least one commitment 303a-c regarding an aspect of the service to be provided. In one exemplary approach, a user may review the contractual SLA commitment 301 and provide user input 315 into SLA creation module 125. User input 315 may determine whether a commitment 303a-c can be converted into a goal 325a-b based on whether the service reports 305 contain an applicable measurement 310a-c related thereto. Accordingly, there is not necessarily a one-to-one mapping of commitments 303a-c to goals 325a-b because service reports 305 may not contain measurements 310a-c related to commitments 303a-c. In another exemplary approach, contractual SLA commitment 301 may be provided in a computer readable format and may be directly input into SLA creation module 125. In such an approach, the contractual SLA commitment 301 may be provided in a structured data format, e.g. XML. Mappings between commitments 303a-c and goals 325a-b may be predetermined and used by an automated process that eliminates the need for user input 315.

The reception of service reports 305 may occur independently from the user input 315. For instance, service reports 305 may be received prior to the reception of user input 315. Additionally, parity between the number of times service reports 305 are received by SLA creation module 125 and the number of times that user input 315 is received by SLA creation module 125 is not required. SLA creation module 125 receives service reports 305 to determine the available measurements 310a-c. In one approach, fields and data from service reports 305 may be presented to the user in order to allow the user to identify the report elements that constitute service level measurements 310a-c. As discussed above, service level measurements 310a-c may include time values related to service issues. However, service level measurements 310a-c may include other aspects of service reports 305. For instance, the mere existence, or quantity, of service reports 305 related to a particular network device 162 may be a service level measurement 310a-c. In another exemplary approach, the available service level measurements 310a-c may be predetermined or preprogrammed into SLA creation module 125. Accordingly, in such an approach, the reception of service reports 305 may not be necessary so long as SLA creation module 125 is aware of the service level measurements 310a-c available from service reports 305.

A plurality of measurable service level agreement commitments 320 may be represented as a set of service level goals 325a-b associated with either the consumer of the service or a management center 103. In another exemplary approach, goals 325a-b are not limited to being associated with only customers or management centers. For instance, goals 325a-b may be associated with a class or grouping of customers, a network device 162, a circuit 170, 180, etc. A measurable SLA commitment 320 may include other attributes that are not shown in FIGS. 2-4 such one or more fields for storing a relationship to customers table 230 or management centers table 240. Associating a set of goals 325a-b with a measurable SLA commitment 320 may allow for a detailed analysis of the actual level of service provided according to multiple measurements 310a-c. Each goal may include a criterion 330a-b, a comparison 335a-b, and a target 340a-b. Criteria 330a-b may be related to measurements 310a-c. For instance, a criterion 330a-b may be an average or a sum of measurement 310a-c over a particular service period. Criteria 330a-b may be further limited to measurements 310a-c for a specific attribute of a network circuit 170, 180 or network device 162. For instance, circuits table 210 includes a transport type field which may indicate the particular network technology of the circuit, e.g. DSL, ATM, etc. Accordingly, criterion 330a-b may be all average of measurement 310a-c for a particular transport type, e.g. average length of service issue for DSL circuits 170. However, criterion 330a-b is not required to be an aggregate value, i.e., sum or average. Criterion 330a-b could be related to a measurement 310a-c of a single service report 305. For instance goal 325a-b may be interpreted to indicate that no single service report 305 related to a DSL circuit should have a service issue length (i.e. a measurement 310a-c) greater than (i.e. a comparison technique 335a-b) 72 hours (i.e. a target 340a-b). Additionally, a criterion 330a-b may be directed at the mere existence of a service report 305. For instance, goat 325a-b may be interpreted to indicate that a particular network device 162 should not have any service reports 305 during the service period.

Target 340a-b may store a value having the same units, e.g., minutes per service period, total hours, unitless, etc, as criteria 330a-b. Target 340a-b may provide a value to use for comparison with the actual level of service related to criterion 330a-b in order to determine whether goal 325a-b has been realized or missed. Comparison technique 335a-b may include an operator for use in an equality or inequality statement. Comparison technique 335a-b may include relational operators such as equals, not equals, greater than, less than, etc. Given the possibility of inequality type comparison techniques 235a-b, i.e. greater than, less than, etc., the ordering of the evaluation statement may affect the result. While the actual level of service may be compared to target 340a-b, or vice versa, the ordering of the evaluation statement must agree with the presentation of the statement in the user interface. For instance, if the user interface presents the ordering of the evaluation statement such that the actual level of service is compared to target 340a-b, then SLA performance module 130 must be configured to conduct the evaluation in the same order. Accordingly, after the conversion of the contractual SLA commitment 301 into a measurable SLA commitment 320, the actual level of service, as ascertained from service reports 305, may be compared to goals 325a-b.

FIG. 4 provides a dataflow diagram illustrating an exemplary flow 400 of data into and out of SLA performance module 130. SLA performance module 130 accepts measurable service level agreements 320 and service reports 305 and produces an SLA performance report 405. The service reports 305 provided to SLA performance module 130 may be limited in order to produce a more fine grained SLA performance report 405. For instance, in order to produce a performance report 405 for a particular customer, only those service reports 305 pertaining to the customer need to be available to SLA performance module 130.

SLA performance module 130 may select goals 325a-b of measurable SLA commitment 320 associated with a customer or management center. SLA performance report 405 may include a set of goal analyses 410a-b. Goal analysis 410a-b may include criteria 330a-b from goals 325a-b as well as explanations 415a-b regarding how goals 325a-b were missed. Explanations 415a-b may include textual sentences regarding the missed goal 325a-b. In another exemplary approach, explanations 415a-b may merely include the actual level of service that corresponds to criteria 330a-b.

While details related to the production of a performance report 405 are provided below with respect to FIG. 5b, the relationship between service reports 305 and performance reports 405 is explained immediately below. SLA performance module 130 may determine the actual level of service provided from measurements 310a-c contained in service reports 305. Accordingly, performance report 405 and any goal analyses 410a-b contained therein, may vary based on the set of service reports 305 used by SLA performance module 130 to produce performance report 405. The inclusion or exclusion of certain service reports 305 may alter performance report 405. Therefore, excluding certain service reports 305 may allow for the isolation of a missed service level goal 325a-b to a particular network device 162, network circuit 170, 180, or even a management center 130. In one approach, SLA performance module 130 may be executed repeatedly, with each iteration excluding service reports 305 related to a particular network device 162 or network circuit 170, 180. The various performance reports 405 that are produced by such an approach may then be compared to determine the effect a device 162 may be having on the service. Similarly, SLA performance module 130 may be executed with service reports 305 related to various customers. SLA performance module 130 may then be executed repeatedly with each iteration excluding service reports 305 related to a particular customer. In such an approach, customers receiving suboptimal or super-optimal service may be identified.

An altered price structure related to the provision of service may be recommended based on any missed goals 325a-b identified in performance report 405. For instance, a consumer of the service may negotiate an appeasement, such as a reduced service fee, based on the quantity of missed goals. Similarly, an appeasement may be based on the severity or degree to which a goal was missed. Moreover, any appeasement may be standardized such that customers having corresponding missed goals 325a-b receive corresponding appeasements. In another exemplary approach, performance reports 405 may indicate that consumers of the service are receiving a level of service that exceeds the agreed upon level. Accordingly, a service provider may wish to renegotiate the contractual SLA commitment 301 in order to receive compensation that is commensurate with the actual level of service provided.

FIG. 5a illustrates a flow chart of an exemplary process 500 for creating a measurable service level agreement 320 by establishing at least one service level goal 325a-b, SLA server 115 may include a computer-readable medium having stored instructions for carrying out certain operations described herein, including some or all of the operations described with respect to process 500. For example, some or all of such instructions may be included in SLA creation module 120. Process 500 is described as an interactive user process. However, it is to be understood that automated or other types of batch processing techniques may implement the following steps.

The process 500 begins in step 505 in which a list of performance criteria 330a-b may be provided. Service level goals 235a-b may be created only for criteria 330a-b having related service level measurements 310a-c. Criteria 330a-b may be directly related to a single measurement 310a-c, or may be related to a group of measurements 310a-c in the aggregate, i.e. sum, average, etc. In one exemplary approach, the list of available criteria 330a-b may be displayed within a graphical user interface provided by SLA server 115 and presented on SLA client workstation 135.

Next, in step 510, a criterion 330a-b may be selected. The graphical user interface may enable a user to choose a criterion 330a-b from the displayed list. In a web based user interface, a web form may include selection controls, e.g. check boxes, drop-down menus, etc. In one exemplary approach, choosing criterion 330a-b may result in the presentation of a new user interface screen for the next step. However in another exemplary approach, the selection of criterion 330a-b may be implemented on the same user interface screen that is used for setting target value 340a-b and comparison technique 335a-b.

Next, in step 515, the target value 340a-b may be set for the criterion 330a-b. The user interface may provide a text entry field to receive an input of target value 340a-b from user. The interface may further present the units of criterion 330a-b following the entry field as a reminder to the user.

Next, in step 520, the comparison technique 335a-b may be set for target 340a-b. A list of comparison techniques 335a-b may be presented to the user. For instance, a drop down menu may include symbols representing various comparison techniques 335a-b, using, for example, Boolean operators such as less than (<), equal (=), not equal (< >), greater than or equal to (≧), etc. In another exemplary approach, the user may be presented with a text entry field for manually entering the symbol corresponding to the comparison technique 335a-b. The presentation of the user interface with respect to the ordering of criterion 330a-b, comparison technique 335a-b, and target 340a-b should correspond with the configuration of the evaluation of the statement in SLA performance module 130.

Next, in step 525, it is determined whether another service level goal 325a-b should be created. The user may be prompted with the question of whether another service level goal 325a-b is desired. The current service level goal 325a-b, including criterion 330a-b, target 340a-b, and comparison technique 335a-b, may be stored as a record in goals table 250. Goal 325a-b may be associated with measurable SLA commitment 320 by including a customer ID or management center ID in the newly created record of goals table 250. Accordingly, all goals 325a-b having the same customer ID represent the measurable SLA commitment 320 of customer. Should a customer or management center require more than one SLA 320, an additional field in goals table 250 may be added to store an SLA identifier. If another goal 325a-b is desired, the process may return to step 505. Following a determination that another goal 325a-b is not desired, the process ends.

FIG. 5b illustrates a flow chart of an exemplary process 550 for generating an SLA performance report 405. SLA server 115 may include a computer-readable medium having stored instructions for carrying out certain operations described herein, including some or all of the operations described with respect to process 550. For example, some or all of such instructions may be included in SLA performance module 125.

The process 550 begins in step 555 in which a service level goal 325a-b may be retrieved for evaluation. SLA data store 120 may be queried for multiple goals 325a-b of goals table 250 at one time. For instance, all goals 325a-b associated with a customer may be supplied by SLA data store 120. Accordingly, the list of all goals 325a-b may be iterated to retrieve a goal 325a-b for evaluation.

Next, in step 560, the actual level of service provided during the service period may be determined based on service level measurements 310a-c of service reports 305. Service reports 305 for the particular service period may be retrieved from SLA data store 120. The set of service reports 305 that is retrieved may be limited to only those reports 305 that are related to a customer if the goal 325a-b being evaluated is associated with the customer. Similarly, if the goal 325a-b is related to a management center, the set of service reports 305 may be limited to only those reports 305 that are associated with the management center. The set of service reports 305 may be further restricted to those related to the criterion 330a-b of goal 325a-b. For instance, if criterion 330a-b is associated with a circuit transport type, e.g. DSL, the set of service reports 305 may be restricted to only those related to DSL circuits.

The selection of service reports 305 may also allow the cause of a missed goal 325a-b to be isolated. Certain service reports 305 may be excluded from the determination of the actual level of service in order to determine the resulting effect on the actual level of service. For instance, SLA performance report 405 may be regenerated multiple times, omitting service reports 305 related to a particular device or circuit each time. Isolating the cause by such an approach may reveal that a particular network device or circuit is responsible for a missed goal 325a-b. Adjustments may be made, such as providing service to the network device or circuit, in order to minimize the likelihood of an additional missed goal 325a-b in a future service period. Similarly, the cause of a missed goal 325a-b may be isolated to a management center. Adjustments may be made, such as training management center personnel, or transferring responsibility for particular devices or circuits to another management center, in order to minimize the likelihood of an additional missed goal 325a-b in a future service period.

After retrieving the relevant set service reports 305, the measurements 31a-c contained therein may be aggregated. The criterion 330a-b may be analyzed to determine the relevant measurement 310a-c. For instance, if criterion 330a-b relates to the average length of service issues, then the lengths of the service issues from the service reports 305 may be averaged. Similarly, if criterion 330a-b relates to the total length of service issues, then the lengths of the service issues may be summed. The aggregate calculations may occur at SLA data store 120 through the query processor, or may occur programmatically in SLA performance module 130. The value calculated from the measurements 310a-c of service reports 305 may therefore represent the actual level of service provided during the service period.

Next, in step 565, service level goal 325a-b may be compared to the actual level of service calculated from the serve level measurements 310a-c. The comparison may involve an evaluation of target 340a-b of goal 325a-b to the actual level of service according to comparison technique 335a-b. The evaluation may determine a missed goal 325a-b for the service period based on the actual level of service not realizing the service level goal 325a-b.

Next, in step 570, a goal analysis 410a-b may be created and added to SLA performance report 405. In one approach, goal analysis 410a-b may be created for each goal 325a-b. However, in another approach, goal analysis 410a-b may be created only for missed goals 325a-b. Criterion 330a-b of goal 325a-b may be recorded in goal analysis 410a-b. Additionally, an explanation 415a-b may be provided with goal analysis 410a-b. Explanation 415a-b may include the actual level of service as well as additional details such as target 340a-b and comparison technique 335a-b.

Next, in step 575, it may be determined whether there are more goals 325a-b to evaluate. If there are remaining goals 325a-b to evaluate, the process may return to step 555. If there are no remaining goals 325a-b to evaluate, the process ends.

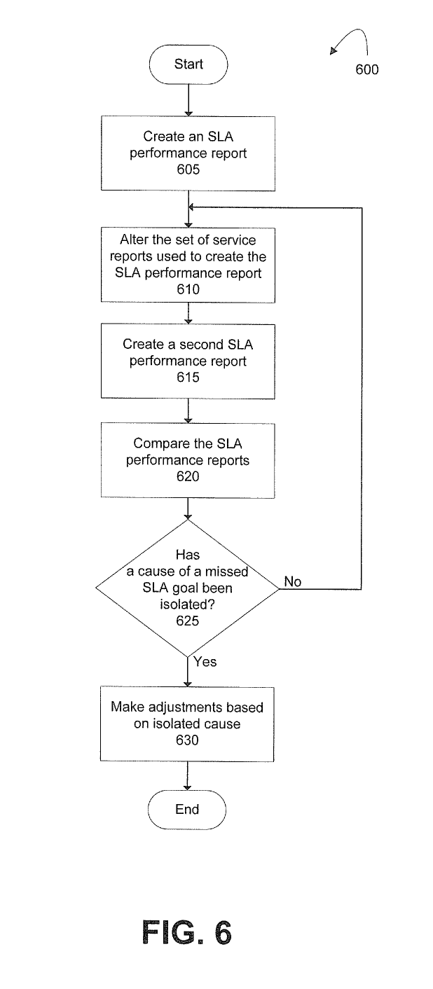

FIG. 6 illustrates a flow chart of an exemplary process 600 for isolating at least one missed goal 325a-b. SLA server 115 may include a computer-readable medium having stored instructions for carrying out certain operations described herein, including some or all of the operations described with respect to process 600. For example, some or all of such instructions may be included in SLA performance module 130.

The process 600 begins in step 605 in which an SLA performance report 405 is created according to process 550. In one exemplary approach, the performance report 405 may be created for a consumer of the service by only including service reports 305 related, directly or indirectly, thereto. However, creating a performance report 405 based on all service reports 305 related to the consumer of the service may blur any associations between particular service reports 305 and missed goals 325a-b. Knowing which service reports 305, and more particularly the subject matter thereof, may allow the service provider to minimize the likelihood of missed goals 325a-b in future service periods. While the following steps are directed at isolating a missed goal 325a-b to a particular network device 162, similar approaches may allow missed goals to be isolated to management center 103. Moreover, similar approaches may allow the actual level of service that is provided to different consumers of the service to be compared in order to identify those consumer receiving suboptimal and super-optimal levels of service.

Next, in step 610, the set of service reports 305 used to create performance report 405 may be altered. In one exemplary approach, a service provider may attempt to isolate a missed goal 325a-b to a particular network device 162. Accordingly, a list of all network devices 162 for which service reports 305 exist for the service period may be generated. The list of devices 162 may then be iterated over in steps 610-625. At each iteration of step 610, the set of service reports 305 may be altered by excluding service reports 305 pertaining to a different network device 162.

Next, in step 615, a second SLA performance report 405 may be generated based on the altered set of service reports 305 from step 610. The service report 405 may be generated according to process 550 as discussed above.

Next, in step 620, the first and second SLA performance reports 405 may be compared. Specifically, the number and severity of any missed goals 325a-b may be compared.

Next, in step 625, it is determined whether the cause of a missed goal 325a-b has been isolated. For instance, if the comparison of the first and second performance report 405 indicated a reduction in the number of missed goals 325a-b or in the severity of missed goals 325a-b, it may be concluded that the cause has been isolated. It is to be understood that more than one device 162 may contribute to missed goals 325a-b. Accordingly, it may be desirable to iterate over the entire list of devices 162 that was identified in step 610. Therefore in another exemplary approach, the performance report 405 calculated in each iteration of step 615 may be stored and compared against each other in order to determine which device 162 contributes most significantly to missed goals 325a-b in the service period. If a cause is not isolated, the process may return to step 610.

After isolating at least one cause of a missed goal 325a-b, adjustments may be made in step 630 in order to minimize the likelihood of an additional missed goal 325a-b in a future service period. For instance, service, or technical support, may be provided to the network device 162 that was identified as the cause of the missed goal 325a-b.

Following step 630, process 600 ends.

Accordingly, system 100 provides SLA system 110 including SLA server 115 and SLA data store 120 for the creation of service level agreements 325 and SLA performance reports 405. SLA creation module 125 may receive a contractual SLA commitment 301, service reports 305, and user input 315 in order to create a measurable service level agreement 325. SLA performance module 130 may receive a measurable service level agreements 325 and service reports 305 in order to generate an SLA performance report 405 including goal analyses 410a-b. Altering the set of service reports 305 provided to SLA performance module 130 may allow for the cause of a missed goal 325a-b to be isolated.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites explicitly to the contrary.

What is claimed is:

1. A method, comprising:
establishing a service level goal related to a provision of service;
measuring, over a service period, at least one service level related to the provision of service;
determining an actual level of service provided for the service period based on the measuring;
comparing the service level goal to the actual level of service;
determining a missed goal for the service period based on the actual level of service not realizing the service level goal;
isolating at least one cause of the missed goal; and
making adjustments related to the at least one cause in order to minimize the likelihood of an additional missed goal in a future service period.

2. The method of claim 1,
wherein the establishing includes
identifying at least one performance criterion, each performance criterion related to the measuring of the at least one service level;
choosing a performance criterion;
setting a target for the criterion; and
setting a comparison technique for the target; and
wherein the determining a missed goal includes evaluating the target for the criterion with the at least one service level related to the criterion according to the comparison technique.

3. The method of claim 1, further comprising:
accessing at least one service report;
providing at least one report measurement from each service report of the at least one service report;
generating the at least one service level from the report measurement of at least one service report.

4. The method of claim 1, wherein the isolating includes determining the at least one cause to be related to a network device, and wherein the making adjustments includes providing service to the network device.

5. The method of claim 1, wherein the isolating includes determining the at least one cause to be related to a management center, and wherein the making adjustments includes transferring at least one network device from the management center to a second management center.

6. The method of claim 1, further comprising altering a pricing structure related to the provision of service based on the missed goal.

7. A method comprising:
measuring, over a service period, at least one service level related to a provision of service;
providing a plurality of performance criteria, each criterion related to the measuring of the at least one service level;
creating a commitment including:
establishing at least one service level goal including:
choosing a performance criterion;
setting a target for the performance criterion; and
setting a comparison technique for the target, and
associating the at least one service level goal with the commitment,
generating a performance report for the service period based on the commitment and the at least one service level;
creating a goal analysis for each service level goal of the commitment, the goal analysis including an evaluation of the target to the service level related to the performance criterion according to the comparison technique; and
incorporating the goal analysis for each service level goal into the performance report.

8. The method of claim 7, further comprising:
determining a missed goal based the service level related to the performance criterion not realizing the target associated therewith;
isolating at least one cause of the missed goal to a network device; and
providing service to the network device in order to minimize the likelihood of an additional missed goal in a future service period.

9. The method of claim 7, further comprising:
determining a missed goal based the service level related to the performance criterion not realizing the target associated therewith; and
isolating at least one cause of the missed goal to a management center; and
making adjustments to the management center in order to minimize the likelihood of an additional missed goal in a future service period.

10. The method of claim 7, further comprising:
accessing at least one service report;
providing at least one report measurement from each service report of the at least one service report;
generating the at least one service level measurement from the report measurement of at least one service report.

11. The method of claim 7, further comprising altering a pricing structure related to the provision of service based on the performance report.

12. A system, comprising:
a service provider network including at least one network device receiving service therefrom according to an actual level of service;
a database containing at least one commitment and at least one service level measurement for a service period;
a monitoring device configured to collect the at least one service level measurement pertaining to the at least one network device; and
a report processor communicatively coupled to the database configured for creating a performance report including: determining the actual level of service provided for the service period based on the at least one measurement; comparing the service level agreement to the actual level of service; and determining a missed goal for the service period based on the actual level of service not realizing the service level goal.

13. The system of claim 12, further comprising an SLA generator communicatively coupled to the database configured for creating the at least one commitment and establishing at least one service level goal for each commitment including: choosing a performance criterion; setting a target for the performance criterion; and setting a comparison technique for the target.

14. The system of claim 12, further comprising at least one service report stored in the database, each report providing at least one report measurement, and wherein the report processor is further configured for generating the at least one service level measurement from the a report measurement of at least one service report.

15. The system of claim 12, wherein the report processor is further configured for:
isolating at least one cause of the missed goal to a network device; and
recommending service to the network device in order to minimize the likelihood of an additional missed goal in a future service period.

16. The system of claim 12, wherein the report processor is further configured for:
isolating at least one cause of the missed goal to a management center; and
recommending an adjustment to the management center in order to minimize the likelihood of an additional missed goal in a future service period.

17. The system of claim 12, wherein the report processor is further configured for recommending an altered pricing structure related to the provision of service based on the performance report.
